(19) United States
(12) Patent Application Publication
(10) Pub. No.: US 2011/0097504 A1
(43) Pub. Date: Apr. 28, 2011

(54) Method for the Anti-Corrosion Processing of a Part by Deposition of a Zirconium and/or Zirconium Alloy Layer

(76) Inventors: Thierry David, Uchaux (FR); Philippe Aubert, Paris (FR); Vincent Royet, Chateaux (FR); Pierre Didier Alain Fauvet, Paris (FR); Raphaël Robin, Britigny Sur Orge (FR); Pascal Aubry, Paris (FR); Véronique Lorentz, Fontenay-Aux-Roses (FR); Maurice Ducos, Mornas (FR); Nadine Goubot, Pont Saint Esprit (FR)

(21) Appl. No.: 12/675,043

(22) PCT Filed: Aug. 29, 2008
(86) PCT No.: PCT/EP2008/061373

§ 371 Date: Feb. 24, 2010

(30) Foreign Application Priority Data
Aug. 31, 2007 (FR) 0757292

(51) Int. Cl. C23C 4/08; B05D 1/02; C23C 4/12

(52) U.S. Cl. 427/455; 427/421.1

(57) ABSTRACT

The invention relates to a method for the anti-corrosion processing of a part that comprises the step of spray deposition of a zirconium and/or zirconium alloy layer onto the surface thereof.

### TECHNICAL FIELD

The invention relates to a method for the anticorrosion treatment of a part, by depositing a layer of zirconium and/or zirconium alloy on said part.

This method is particularly suitable for protecting parts intended to be brought into contact with an acid medium, such as a medium containing nitric acid, encountered especially in the chemical industry in general and in the nuclear field in particular.

The general field of the invention is therefore that of corrosion.

### PRIOR ART

According to the ISO 8044 standard corrosion means the physico-chemical interaction between a metal and its surrounding medium leading to modifications in the properties of the metal and often to a functional degradation of the metal, of its environment or of the chemical system formed by the two factors.

More commonly, corrosion means the impairment of an object by reaction with oxygen, the most common examples being the chemical impairment of metals in water, such as the rusting of iron or the formation of verdigns on copper and alloys thereof such as bronze and brass.

To combat corrosion, the primary idea may consist in choosing a material that does not corrode in the environment in question. Such a material may be stainless steel, for example, containing especially chromium. The formation of chromium oxides on the surface thus impedes the progress of oxygen and, as a consequence, the depth-wise propagation of the corrosion phenomenon.

However, stainless steel has a corrosion resistance limited to weakly oxidizing and acidic media. Steel is therefore not very suitable for highly acidic media, such as those containing nitric acid, which are encountered in the nuclear field and in the chemical industry.

It is also conceivable to vary the design of the part so as to avoid areas of confinement, contacts between different materials and, in general, heterogeneities, which often form the starting point for corrosion. Another solution may consist in controlling the characteristics of the environment, especially by modifying the parameters that have an influence on corrosion, such as the chemical composition (such as acidity, temperature and oxidizing power). However, this type of solution is conceivable only in a limited number of cases, especially in a closed medium.

Lastly, a final solution may consist in isolating the part from the corrosive environment, especially by protecting the part with a layer of paint or plastic, or else by introducing another part in order to disturb the reaction (sacrificial anode principle), this new part corroding instead of the part to be protected. However, these solutions are not suitable for highly acidic environments, such as those encountered in the nuclear field.

There is therefore a real need for an anticorrosion treatment method for providing effective protection of parts in highly corrosive media, especially acid media, such as those containing nitric acid, which are encountered in the nuclear field, which method is, moreover, simple to implement and inexpensive.

### SUMMARY OF THE INVENTION

The inventors have discovered, surprisingly that by depositing a thin layer of a particular metallic element and/or an alloy thereof on the part to be protected under particular conditions, it is possible to meet the abovementioned need effectively.

Thus, the invention relates to a method for the anticorrosion treatment of a part, which includes a step of depositing a layer of zirconium and/or zirconium alloy on the surface of said part by spraying, said part being advantageously maintained at a temperature below 200° C. during the deposition step.

The term “zirconium alloy” is understood to mean, as is conventional, a blend of zirconium, present in a predominant amount (more than 50% by weight), and another metallic element chosen, for example, from hafnium, iron, chromium, tin, nickel, niobium, copper and blends thereof.

This anticorrosion treatment method is particularly advantageous in that zirconium is an element having very beneficial corrosion resistance properties in most aggressive aqueous media. The inalterability of zirconium derives from its very great affinity for oxygen and from the characteristics of the oxide film formed, this film having high coverage, strong adhesion and great chemical stability.

This method is simple to implement since, advantageously, it does not require subsequent treatment steps after the deposition step. Thus, the method of the invention may, advantageously, consist solely of a deposition step by spraying a layer of zirconium and/or zirconium alloy on the surface of a part, said part being advantageously maintained at a temperature below 200° C. during the deposition step.

More specifically, zirconium and alloys thereof have, in an oxidizing medium of the nitric acid type, excellent corrosion resistance for a very wide range of concentrations and temperatures. For example, when in contact with a boiling nitric acid solution with an acid concentration up to 24 mol/l, the corrosion rate of zirconium remains less than 4.5 mg.dm⁻² per day (i.e. 25 μm per year), the corrosion morphology being that of generalized corrosion. When in contact with a boiling sulfuric acid solution with an acid concentration up to 14 mol/l the corrosion rate remains less than 18 mg.dm⁻² per day (i.e. 100 μm/year).

Zirconium and its alloys are therefore particularly advantageous for forming a coating on parts intended to be in contact with an aggressive aqueous medium.

Advantageously, the deposited layer is made of zirconium (i.e. not made of a zirconium alloy), pure zirconium being even more effective than its alloys in terms of corrosion resistance.

This method may be intended for coating new parts or else for resurfacing corroded parts (especially in a nuclear environment).

This layer of zirconium and/or zirconium alloy may have a thickness ranging up to 2 mm and advantageously contains no oxide(s).

Advantageously, the deposition step may be carried out by a technique chosen from: electric arc spraying; HVOF thermal spraying; plasma spraying; and cold spraying.

Most particularly, the deposition step is carried out by the preferential technique of cold spraying.

These techniques are particularly suitable for obtaining a dense layer of zirconium and/or zirconium alloy advantageously containing no oxide(s) and having good adhesion to the part.

Thus, according to a first embodiment, the step of depositing the layer of zirconium and/or zirconium alloy is carried by electric arc spraying (also called arc spray technology).

The principle of electric arc spraying consists in drawing an electric arc between two consumable conducting wires (in this case here zirconium and/or zirconium alloy wires), which fulfill both an electrode function and a filler material function for forming the layer. In particular, the wires may be annealed zirconium and zirconium alloy wires having a diameter of 1.6 mm. The molten metal, resulting from the consumable conducting wires melting upon contact with the arc, is then sprayed onto the part to be treated by a jet of inert gas, such as argon.

This embodiment is particularly appropriate to the production of coatings on parts intended to be exposed to an acid environment, such as a medium comprising 11 mol/l nitric acid at a temperature of 60° C., whether this coating is intended for coating a new part or for repairing a part that has been damaged.

According to a second embodiment, the step of depositing the zirconium and/or zirconium alloy layer may be carried out by HVOF (high-velocity oxy-fuel) thermal spraying, also called high-velocity oxygen-fuel flame spraying.

HVOF thermal spraying is a supersonic flame spraying method in which the energy needed to melt and accelerate the filler material (here, zirconium or zirconium alloy) is obtained by the combustion of a fuel in gaseous form (for example, propane, propylene, hydrogen, acetylene or natural gas) or in liquid form (such as kerosene) in oxygen, the fuel and the oxidizer being, for example, in the form of a stoichiometric mixture. It is also possible to use, in addition to the abovementioned mixture, a propellant gas, preferably an inert gas such as argon. The filler material is conventionally in the form of zirconium and/or zirconium alloy wires. In particular, the wires may be annealed zirconium and/or zirconium alloy wires having a diameter of 1.6 mm.

The gases burnt in a combustion chamber generally flow into a nozzle, wherein they are accelerated, reaching a supersonic velocity (for example, around 700 m/s) at the nozzle outlet, and contribute in transporting the zirconium injected into the same nozzle.

The temperatures (for example ranging from 2000 to 4000° C.) and the velocities reached by the gas jet (for example ranging from 1800 to 2200 m/s) make it possible, on contact with the zirconium, to melt it and spray it with a high velocity onto the part to be coated. This results in excellent bonding of the zirconium and/or the zirconium alloy to the part, low porosity and low surface roughness of the deposited layer.

It may be advantageous to maintain the part to be coated at a temperature below 100° C. in order to further improve bonding quality.

According to a third embodiment, the step of depositing the zirconium and/or zirconium alloy layer may be carried out by plasma spraying.

The principle of plasma spraying consists in spraying molten particles which, through the effect of temperature and velocity, are flattened on the surface of the part to be treated, to which they are mechanically bonded.

More precisely, a high-frequency electric arc is struck, and sustained by a low-voltage current source in a stream of plasma gas between a cathode (generally of axial shape, and made of a material such as tungsten) and an anode (generally of nozzle shape, and made of a material such as copper), the cathode and the anode both being cooled by a cooling system (such as a water cooling system). The plasma gas may be argon, nitrogen or mixtures thereof, optionally in the presence of hydrogen and/or helium. Owing to the high temperatures, the gas molecules dissociate and then ionize, resulting in a highly conducting medium enabling an electric arc to be sustained between the cathode and the anode between which there is a potential difference.

During its passage through the anode, the plasma gas, which has moreover expanded considerably (possibly by up to more than 100 times its initial volume), helps to constrict the arc, this having the effect of raising the temperature and forcing the gas to be expelled from the anode in the form of a plasma. The plasma, consisting of dissociated and partially ionized gases, emerges from the nozzle-shaped anode at a high velocity (possibly of the order of Mach 1) and at high temperature (for example, ranging from 10 000 K to 14 000 K).

The zirconium and/or zirconium alloy in powder form, pre-suspended in a carrier gas, is injected into the plasma in the nozzle anode or more generally at the outlet thereof. The particles, which are accelerated and melted, are sprayed onto the surface of the part to be coated with a very high kinetic energy thereby achieving optimum bonding.

This embodiment is particularly suitable for the production of coatings on new parts intended to be exposed to an acid environment, such as a medium comprising 11 mol/l nitric acid at a temperature of 60° C.

According to a fourth embodiment, the step of depositing the zirconium and/or zirconium alloy layer may be carried out by cold spraying, this being the preferential technique of the invention.

The principle of cold spraying consists in accelerating a gas (such as nitrogen, helium or argon), heated to a temperature that may range from 100 to 700° C., to supersonic velocities in a de Laval nozzle and then the powder of material to be sprayed (here, the zirconium and/or zirconium alloy powder) is introduced into the high-pressure part (at between 10 and 40 bar) of the nozzle and is sprayed “in the unmelted state” onto the surface of the part to be coated with a velocity that may range from 600 to 1200 m/s. On contact with the part, the particles undergo plastic deformation and form, upon impact, a dense adherent coating.

The advantage of this embodiment lies in the non-melting of the particles, and therefore in a very low risk of oxidation and possible integration in a hostile environment.

This embodiment is particularly suitable for producing coatings on parts intended to be exposed to an acid environment, such as an 11 mol/l nitric acid medium at a temperature of 60° C. or a 14 mol/l nitric acid medium at 120° C., whether this coating is intended to be placed on a new part or to repair a part that has been damaged.

Irrespective of the embodiment envisioned, the deposition step is also advantageously carried out in an inert gas atmosphere (such as an argon atmosphere), especially so as to reduce the risk of pyrophoricity of zirconium powder.

The deposition step may be carried out in the presence of a cooling system or an inert-gas propulsion system.

Advantageously, the part to be coated, in particular except in the case of laser deposition, is maintained at a temperature below 200° C. during the deposition step so as to ensure good cohesion with the substrate.

The metal parts that can be treated by the method of the invention may be parts made of steel, parts made of zirconium or zirconium-based alloys; and parts made of iron or iron-based alloys.

In particular, the metal parts, when they are made of steel, may be parts made of ferritic stainless steel, martensitic stainless steel and, in particular, by precipitation hardening austenitic, ferritic-martensitic or ferritic-austenitic stainless steel, corresponding to the grades described in the NF EN 10088 standard (such as the steels X 2 CN 18-10, X 2 CND 17-13, X 2 CN 25-20 and X 2 CNS 18-15).

The metal parts that can be treated by the method of the invention may also be parts made of zirconium or zirconium-based alloys. In this case, the purpose of the method may be, apart from protecting the part from corrosion, to resurface said zirconium part, for example to carry out repairs on said part that has been damaged.

This treatment method is applicable for parts exposed to a corrosive environment, such as those used in equipment intended for the steps in reprocessing spent fuel or, more generally, such as those used in the chemical industry employing oxidizing acids (such as nitric acid and sulfuric acid).

The invention will now be described in relation to the following embodiments given by way of illustration but implying no limitation.

### DETAILED DESCRIPTION OF PARTICULAR EMBODIMENTS

The following examples illustrate various embodiments of the invention, each of them illustrating one particular spraying technique.

### Example 1

This example illustrates the deposition of a zirconium layer by electric arc spraying on a part made of 304L stainless steel or of zirconium.

The apparatus used for this spraying was a TAFA 9000 arc spray apparatus. It consisted of a generator module comprising integrated coils of wire and a gun. The gun was mounted on a robot, enabling better uniformity of the covering of the various passes to be achieved. The propellant gas used was argon. The gun was equipped with an arc jet device, which made it possible for the particle velocity to be increased and for the particles to be better sheathed in an argon atmosphere as far as the part forming the substrate.

Prior to deposition, the part to be treated was descaled by the impact of abrasive grit (white corundum), air was then blown onto the part thus descaled, which was then cleaned with alcohol.

The temperature of the part was below 200° C. during spraying.

The spraying conditions are given in Table I below:

| Characteristic | Value | |
|---|---|---|
| Current | 140 | A |
| Voltage | 23 | V |
| Firing distance | 0.1 | m |
| Gun displacement speed | 1 | m/s |
| Arc jet pressure | 413685 | Pa |
| Number of passes | 55 | |
| Deposited thickness | 0.002 | m |

The use of argon as propellant/cooling gas made it possible to deposit a uniform dense coating with a low oxide content and an adhesive strength of about 11 MPa. The hardness of the coating was about 200 Hv, this being comparable to that of bulk zirconium (190 Hv).

The corrosion tests, by samples being immersed in the 11 mol/l nitric acid solution at a temperature of 60° C. for 800 hours showed no evidence of degradation of the layer deposited beforehand. The weight change was less than 2 mg/dm².

### Example 2

This example illustrates the deposition of a zirconium layer by HVOF thermal spraying on a part made of zirconium or of 304L steel.

The apparatus used for this thermal spraying was a model 2000 HV WIRE System. The spray gun was mounted on a motor-driven linear carriage, the speed of which could be adjusted, the shifts between each pass being performed manually. The wire was fed into the gun by a conventional (“push-pull”) device enabling the wire speed to be varied, and therefore enabling the amount of consumed material to be determined.

The spraying conditions are given in Table II below.

| Characteristic | Value | |
|---|---|---|
| Oxygen | Pressure: 600 000 Pa | |
| | Flow rate: 1.06 l/s | |
| Propylene | Pressure: 500 000 Pa | |
| | Flow rate: 0.2 l/s | |
| Argon | Pressure: 600 000 Pa | |
| | Flow rate: 0.1 l/s | |
| Firing distance | 0.15 | m |
| Gun displacement speed | 0.05 | m/s |
| Wire speed | 0.01 | m/s |
| | Flow rate: 0.67 g/s | |
| Number of passes | 40 | |
| Deposited thickness | 0.0014 | m |

The originality in using this method was to use argon as propellant gas, to work with a stoechiometric combustion gas mixture, to maintain the temperature of the part at below 200° C. by suitable cooling and to limit the thickness per pass to the smallest possible amount.

The coatings deposited were homogeneous and dense.

The hardness of this layer was identical to that of bulk zirconium (190 Hv).

The corrosion tests, by samples being immersed in the 11 mol/l nitric acid solution at a temperature of 60° C. for 800 hours showed no evidence of degradation of the layer deposited beforehand. The weight change was less than 2 mg/dm².

### Example 3

This example illustrates the deposition of a zirconium layer by plasma spraying on a part made of 304L stainless steel or zirconium.

The apparatus used was a conventional torch (Metco F4 torch) in a chamber of 18 m³ volume, which was placed in a controlled (argon) atmosphere. A 6-axis robot was integrated in the booth, enabling parts of complex shape to be produced. The advantage of depositing coatings with this type of installation lies in the use of an argon atmosphere, which limits oxidation of the zirconium.

The part to be treated was descaled by impact with an abrasive grit (white corundum, having a particle size of 700 μm) at a pressure of 4.5 bar and at an angle of 45°, so as to minimize incrustation in the substrate.

To reduce the amount of oxide in the coating, the chamber was pre-evacuated several times before the spraying, and an additional cooler (a slot cooler from Fenwick) was added at the torch outlet in addition to the two Emani nozzles, thereby avoiding the residual oxygen being combined with the molten powder during spraying. This system also enabled the temperature of the part to be reduced.

The spraying conditions are given in Table III below.

| Torch type | 6 mm F4 nozzle | |
|---|---|---|
| Chamber pressure | 110 000 | Pa |
| Current | 650 | A |
| Voltage | 67.8 | V |
| Power | 44.1 | kW |
| Argon flow rate | 0.78 | l/s |
| Hydrogen flow rate | 0.3 | l/s |
| Powder flow rate | 0.42 | g/s |
| Spraying distance | 0.075 | m |
| Torch speed: step size | 0.2 m/s: 5 mm | |
| Number of passes | 65 | |
| Deposited thickness | 0.002 | m |

The coating deposited was homogeneous and dense, containing no oxide, with a thickness in the millimeter range and with no cracking between the layer and the part. The adhesive strength was between 31 and 43 MPa. The hardness of the layer was identical to that of bulk zirconium (190 Hv).

The corrosion tests, by samples being immersed in the 11 mol/l nitric acid solution at a temperature of 60° C. for 800 hours showed no evidence of appreciable degradation of the layer. The weight change was less than 2 mg/dm².

### Example 4

This example illustrates the deposition of a zirconium layer by cold spraying on a part made of 304 L stainless steel or zirconium.

The apparatus used consisted of a spray booth, a robot, a gun, a generator, a powder dispenser and a gas heater.

The spraying conditions are given in Table IV below.

| Characteristic | Value | |
|---|---|---|
| Gas | Nitrogen | |
| Gas pressure | 390 000 | Pa |
| Gas flow rate | 0.025 | m³/s |
| Gas temperature | 390° | C. |
| Spraying distance | 0.04 | m |
| Torch speed | 0.666 m/s: 1.5 mm | |
| Number of passes | 40 | |
| Deposited thickness | 0.002 | m |

The coatings deposited were homogeneous and dense, containing no oxides.

The hardness of the deposited layer was about 350 Hv, this value being higher than that of bulk zirconium. Such a hardness derives from the process, since the layer is produced by the stacking of successive sublayers, and the high velocity of the particles causes a work-hardening phenomenon, thereby increasing the hardness of the layer. This has a benefit in that the layer can provide both a corrosion-resistance function and a wear-resistance function.

The corrosion tests, by immersion in an 11 mol/l nitric acid solution at a temperature of 60° C. for 800 hours, showed no evidence of degradation of the deposited layer. Another test in a 14 mol/l nitric acid solution at a temperature of 120° C. for 168 hours also showed no evidence of degradation of the deposited layer. The weight change was less that 3 mg/dm².

1-10. (canceled)

11. A method for the anticorrosion treatment of a part, which includes a step of depositing a layer of zirconium and/or zirconium alloy containing no oxide on the surface of said part by spraying, said part being maintained at a temperature below 200° C. during the deposition step.

12. The anticorrosion treatment method as claimed in claim 11, consisting solely of the deposition step.

13. The treatment method as claimed in claim 11, in which the layer of zirconium and/or zirconium alloy has a thickness ranging up to 2 mm.

14. The treatment method as claimed in claim 11, in which the layer is made of zirconium.

15. The treatment method as claimed in claim 11, in which the deposition step is carried out by a technique chosen from among: electric arc spraying, HVOF thermal spraying, plasma spraying, and cold spraying.

16. The treatment method as claimed in claim 11, in which the deposition step is carried out by cold spraying.

17. The treatment method as claimed in claim 11, in which the deposition step is carried out in an inert gas atmosphere.

18. The treatment method as claimed in claim 11, in which the part to be treated is chosen from among: parts made of steel, parts made of zirconium or zirconium-based alloys, and parts made of iron or iron-based alloys.

19. The treatment method as claimed in claim 18, in which the part to be treated is made of ferritic, martensitic, austenitic, ferritic-martensitic or ferritic-austenitic stainless steel.
